(19) United States
(12) Patent Application Publication
(10) Pub. No.: US 2004/0131297 A1
(43) Pub. Date: Jul. 8, 2004

(54) Profiled roller bearing

(76) Inventor: Dirk-Olaf Leimann, Edegem (BE)

Correspondence Address: YOUNG & THOMPSON, 745 SOUTH 23RD STREET 2ND FLOOR, ARLINGTON, VA, 22202

(21) Appl. No.: 10/473,017

(22) PCT Filed: Mar. 25, 2002
(86) PCT No.: PCT/IB02/02130

(30) Foreign Application Priority Data
Mar. 27, 2001 (GB) 0107616.5

(51) Int. Cl. F16C 33/58

(52) U.S. Cl. 384/571

(57) ABSTRACT

The invention relates to a roller bearing in which high edge stresses resulting from shaft misalignment can be mitigated or overcome. The invention provides a roller bearing comprising an inner, an outer ring and a plurality of bearing rollers disposed therebetween wherein the outer bearing ring has an axial end face and a grooved formed therein, the groove extending longitudinally about the axis of rotation of the bearing. The groove may be formed between the radially inner and outer edges of the end face or may be formed at the radially outer edge, and have the form of a chamfer. The groove may be continuous or discontinuous around the end face.

This invention relates to a roller bearing assembly and in particular, though not exclusively, to a gear unit comprising a housing and gear shafts rotatably supported relative to the. housing by means of taper or cylindrical roller bearings.

In accordance with the recommendations of bearing manufacturers it is conventional to provide a shrink type fit between the inner ring, (cone), of a taper roller bearing and the surface of a gear shaft. The shrink fit is necessary in order to avoid or minimise the risk of fretting corrosion and other damage.

In contrast to the shrink fit requirement for the inner ring, the outer ring of a roller bearing of the taper type does not need to be a tight fit in the housing because of the point type loading experienced by the outer ring.

Whilst a shrink fit is not required between the outer ring of each bearing and the housing wall, the housing wall nevertheless requires to be sufficiently stiff-in order that the bearing is properly located axially and in order that required preload or clearance is maintained despite axial forces arising in consequence of any helical gear carried by a shaft and which would tend to distort a housing wall.

The operating life of bearings of both the taper and cylindrical roller types is dependant also on the degree of misalignment which might arise in use between the rotational axis of the shaft to which the inner bearing ring is secured, and the location of the outer bearing ring. Particularly in the case of those gear stages of a multistage gear box that are subject to higher loads, the shaft misalignment can be significant and the consequential high edge stresses experienced by the bearing can result in an undesirable reduction in the satisfactory working life of the bearing.

The present invention seeks to provide a rollerbearing assembly in which the aforedescribed difficulties are mitigated or overcome.

In accordance with one aspect of the present invention there is provided a roller bearing comprising an inner ring, an outer ring. and a plurality of bearing rollers disposed therebetween wherein the outer bearing ring has an axial end face and a groove formed therein.

Said groove may be circumferentially continuous, or, in e.g. a case in which the outer ring is intended to be loaded in use primarily only in one or a limited angular range of directions, it may extend around only part of the end face, about the axis of rotation of the bearing.

The axial depth of the groove, as considered in a direction parallel with the axis of rotation of the bearing, preferably ties between 10% and 75%, more preferably between 15% and 50% of the axial length of bearing outer ring.

The roller bearing may be of the type comprising cylindrical rollers, or tapered rollers. In the case of a taper roller bearing, for which the radial dimension of the end face of the outer ring is greater at one axial end of the outer ring than at the other end, it may be arranged that in use the point of maximum stress in the bearing occurs in the vicinity of that end of the bearing having the greater radial dimension to the outer ring, and the groove may be formed in said end face of greater radial dimension. The invention does not exclude, however, provision of a groove at the smaller radial end of the outer ring of a tapered roller bearing.

For both cylindrical and taper type roller bearings a groove may be provided in either one or each of the axial end faces of the outer ring.

The invention teaches also that the groove may be in the form of a chamfer provided at the radially outer surface of the bearing outer ring. Thus whilst conventionally an outer ring has a cylindrical radially outer shape, in accordance with the present invention it is provided that the cylindrical shape may extend along only part of the axial length of the outer surface, with the remaining axial length departing from said cylindrical shape, for example to be of a frusto-conical shape.

In accordance with a further aspect of the present invention there is provided a roller bearing assembly comprising a housing which defines a tubular housing formation and a roller bearing having the outer ring of the roller bearing located within said tubular housing formation, an axial end face of the assembly, as considered in an axial direction parallel with the axis of rotation of the bearing. comprising a groove positioned radially between the radially inner surface of the bearing outer ring and the radially inwardly facing surface of the tubular housing formation.

Said groove may be defined by axially extending groove side walls formed in the outer ring of the bearing or may be defined in part by the outer surface of the bearing outer ring and in part by said radially inwardly facing surface of the tubular housing formation.

The radial dimension of the groove preferably is less than 70%, more preferably less than 60% of the radial thickness of the outer ring as considered at local axial positions between the axial ends of the outer ring.

Examples of cross-sectional shapes of a groove include a square, rectangular and triangular shape, but it is to be understood that other shapes or combinations of shapes may be employed. Similarly, in the case of a groove defined in. an assembly by a space between the outer ring and the aperture of a housing formation, the aforementioned shape and dimensional features of a groove formed within an outer ring of a bearing similarly may be employed.

The thickness of the outer ring between the radially inner raceway surface and the groove formed in the thickness of the ring or the shape and/or the manner in which the housing supports the ring over only part of the axial length of the bearing ring thereby may assist in allowing the raceway to deform elastically under load in a manner which tends to follow distortion of the shaft when operating under load.

Embodiments of the present invention will now be described, by way of example only, with reference to the accompanying diagrammatic drawings in which:

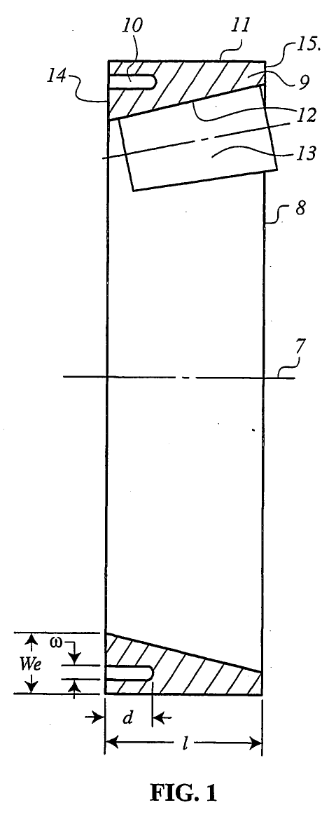

FIGS. 1 to 3 each show in cross-section part of a tapered roller bearing in accordance with the present invention;

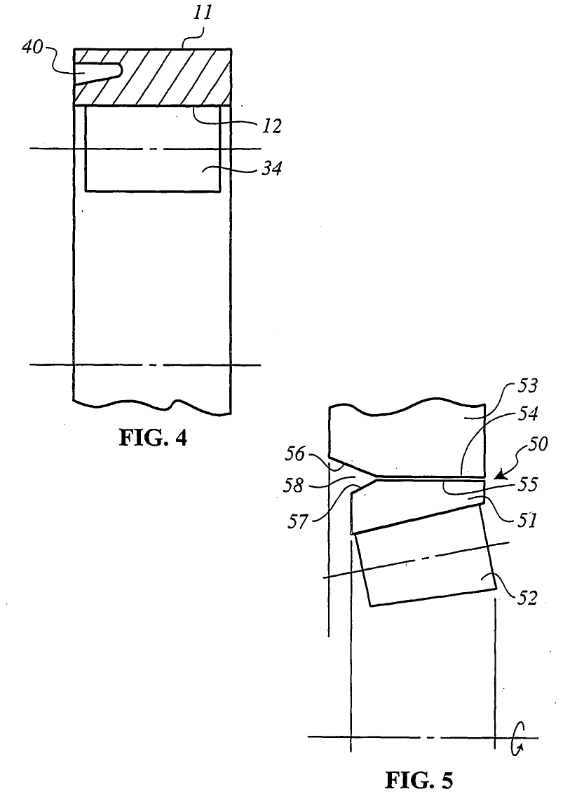

FIG. 4 shows part of a cylindrical roller bearing in accordance with the present invention; and

FIG. 5 shows part of a bearing assembly in accordance with the present invention.

FIG. 1 shows the outer ring 9 and a taper roller 13 forming part of a taper roller bearing 8 rotatable about an axis 7.

The outer ring 9 comprises a radially outer cylindrical surface 11 and a frusto-conical radially inwardly facing surface 12 over which the roller 13 rotates.

The outer ring 9 has an end face 14 of greater radial dimension than the other end face 15. The end face 14 is formed with a circumferentially continuous groove 10 the radial dimension w of which is less than 10% of the local radial thickness We of the ring 9 at all axial positions of the groove. The groove depth d being axial length of the groove as considered in a direction parallel with the axis 7 in this embodiment is approximately 25% of the axial length 1 of the outer ring 9. The groove of this embodiment has a substantially rectangular shape, comprising a pair of parallel side walls and a base which for manufacturing convenience and to avoid stress concentrations is of a slightly curved profile.

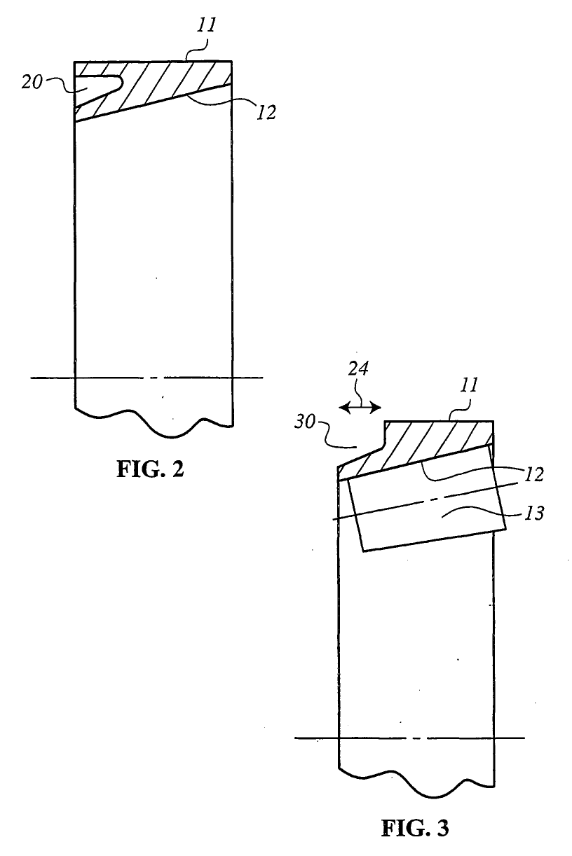

FIG. 2 shows variation of the embodiment of FIG. 1 in which the bearing outer ring comprises between radially outer and inner faces 11, 12 a circumferentially continious groove 20 of a substantially triangular shape in common with the groove of the FIG. 1 embodiments the groove 20 has a slightly curved base region to avoid stress concentrations.

FIG. 3 shows a variation in which the radially outer surface 11 of the outer ring is cylindrical over any part of the axial length and for the remainder 24 is cut away to provide a recess region 30.

FIG. 4 shows a construction substantially similar to that of FIG. 2, but comprising a cylindrical roller bearing 34 and a groove 40 of truncated triangular shape provided in one of the axial end faces of the bearing outer ring. FIG. 5 illustrates a bearing assembly comprising a bearing outer ring 51 and a taper roller 52 with the bearing outer ring 51 located within a tubular aperture formation defined by a housing 53.

The bearing outer ring 51 has a cylindrical shape over a part 55 of the axial length thereof, and said part of the outer ring is tight fit in a cylindrical portion 54 of the aperture defined by the housing 53.

The remainder of the axial length of the outer surface of the bearing outer ring 51 is comprised by a frusto-conical shape surface 57. Similarly, the remainder of the axial length of the aperture of the housing 53 is defined by a frusto-conical shape surface 56. A groove region 58 is thereby formed between the confronting surfaces 56, 57. In use of the bearing when subjected forces caused by bending of a shaft rotatably carried by the bearing, the end of the bearing outer ring 51 in a vicinity of the frusto-conical surface 57 is able to elastically deform radially outwards more readily than the part of the bearing outer ring contained within the cylindrical surface portion 54, and the occurrence of localised and undesirable stress concentrations on the bearing, in particular between the roller 52 and radially inner surface of the outer ring, is there by reduced or avoided.

1. A roller bearing (8) comprising an inner ring, an outer ring (9,51) having two axial end faces (14,15). and a plurality of tapered bearing rollers (13,52) disposed therebetween wherein the outer bearing ring has an a circumferentially continuous groove (10,20,30,40.58) formed in that axial end face (14) having the greater radial dimension, the groove (10,20,30,40,58) extending longitudinally about the axis of rotation (7) of the bearing.

2. A roller bearing according to claim 1 wherein the groove is formed at the radially outer edge of the end face.

3. A roller bearing according to claim 1 wherein the groove is formed between the radially inner and radially outer edges of the end face (14).

4. A roller bearing according to any of the preceding claims wherein the axial depth (d) of the groove (10.20,30,40,58) is between 10% and 75% of the axial length (1) of the outer ring (9,51).

5. A roller bearing according to claim 4 wherein the axial depth (d) of the groove (10,20,30,40,58) is between 15% and 50% of the axial length (1) of the outer ring (9,51).

6. A roller bearing according to any of the preceding claims wherein the radial dimension (w) of the groove (10,20,30,40,58) is less than 70% of the radial thickness (We) of the outer ring (9,51) as considered at local axial positions between the axial ends (14.15) of the outer ring (9,51).

7. A roller bearing according to claim 6 wherein the radial dimension (w) of the groove (10,20,30,40,58) is less than 50% of the radial thickness (We) of the outer ring (9,51) considered at local axial positions between the axial ends (14,15) of the outer ring (9,51).

8. A roller bearing according to any of the previous claims wherein a groove (10,20,30,40,58) is formed in both axial end faces (14,15) of the outer ring (9,51).

9. A roller bearing substantially as described herein and depicted in FIGS. 1 to 5.

10. A roller bearing assembly comprising a housing which defines a tubular housing formation and a roller bearing having the outer ring of the roller bearing located within said tubular housing formation. an axial end face of the assembly, as considered in an axial direction parallel with the axis of rotation of the bearing, comprising a groove position radially between the radially inner surface of the bearing outer ring and the radially inwardly facing surface of the tubular housing formation.

11. A roller bearing assembly according to claim 10 wherein the groove is defined in part by the radially inwardly facing surface of the tubular housing formation.

12. A roller bearing assembly according to either of claims 10 or 11 comprising a bearing inner ring which is a shrink fit on a shaft

13. A roller bearing assembly according to any of claims 10 to 12 wherein the outer ring is not a tight fit in the housing.

14. A roller bearing assembly as substantially described herein and depicted in FIGS. 1 to 5.
